(19) United States
(12) Patent Application Publication
(10) Pub. No.: US 2011/0241338 A1
(43) Pub. Date: Oct. 6, 2011

(54) CONDUIT SYSTEM

(76) Inventor: William Tydings, Edgewater, MD (US)

(21) Appl. No.: 13/072,713

(22) Filed: Mar. 27, 2011

Related U.S. Application Data
(60) Provisional application No. 61/320,251, filed on Apr. 1, 2010.

(51) Int. Cl. F16L 25/00; B23P 11/00

(52) U.S. Cl. 285/330; 29/428

(57) ABSTRACT

A conduit system includes a pipe having a male end and a female end; the pipe having a flare near the female end of the pipe, adapted to accept the male end of a second pipe to form a continuous conduit system; a plurality of pins, extruding on an exterior surface near the male end; and a slot near the female end, having a plurality of pin keepers that correspond to the pins, to retain the pipe to the second pipe. The pipe may be electrical metallic tubing, and may have alignment marks.

### RELATED APPLICATIONS

This application claims the benefit of the filing date of U.S. Patent Application No. 61/320,251, filed Apr. 1, 2010, which is incorporated herein by reference in its entirety.

### BACKGROUND OF THE INVENTION

The present invention generally relates to conduit and more specifically to a system that supports the installation of electrical metallic tubing that reduces labor costs.

Currently, installation of conduit systems may have high labor costs, even for material handling of standard conduit fittings. Connections at coupling joints and conduit terminations, for example, electrical boxes, load center, wire ways, etc.

Existing applications may also provide liquid or fluid-tight gaskets, which are often not necessary. Installations that use electrical metallic tubing (EMT) generally do not require or benefit from an air-tight seal.

It would be desirable to have a conduit system for electrical metallic tubing that is easy connected, which can be installed in less time than standard fittings.

### SUMMARY OF THE INVENTION

In one aspect of the present invention, a device includes a pipe having a male shape at a first end and a female shape at a second end, the female shape having a flare adapted to accept the male shape; a pin on an exterior surface of the pipe, having a pin shape; and a slot in the pipe, adapted to receive and retain the pin shape, thereby providing a section of conduit.

In another aspect of the present invention, a conduit system includes a pipe having a male end and a female end; the pipe having a flare near the female end of the pipe, adapted to accept the male end of a second pipe to form a continuous conduit system; a plurality of pins, extruding on an exterior surface near the male end; and a slot near the female end, having a plurality of pin keepers that correspond to the pins, to retain the pipe to the second pipe.

In yet another aspect of the present invention, a method for a conduit system includes providing a first pipe having a male shape at a first end, a pin on an exterior surface near the first end, a female, flared shape at a second end, and a pin keeper near the second end; attaching a similar second pipe to the first pipe so that the pin of the first pipe and the pin keeper of the second pipe engage to retain the first pipe to the second pipe; and attaching a third pipe to the first pipe and to an external fixture.

### BRIEF DESCRIPTION OF THE DRAWINGS

FIG. 1 is a bottom view of an exemplary embodiment of the present invention;

FIG. 2 is a top view of the embodiment of FIG. 1;

FIG. 3 is a top view of the embodiment of FIG. 1 illustrating the connection between male and female ends;

FIGS. 4A, 4B, 4C and 4D depict embodiments of the present invention with a threaded adapter for an external fixture; and

FIGS. 5A and 5B depict embodiments of the present invention with set screws for an external fixture.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly an embodiment of the present invention generally provides a conduit system. More specifically, the current invention provides electrical metallic tubing that may be installed quickly, safely, and easily.

More specifically, a conduit system may comprise a pipe which has a male end and a female end. The male end may have a plurality of pins extruding on an exterior surface of the pipe. Furthermore, the female end may have a flared end, a slot, and a plurality of pin keepers. These features may help the female end to accept the male end.

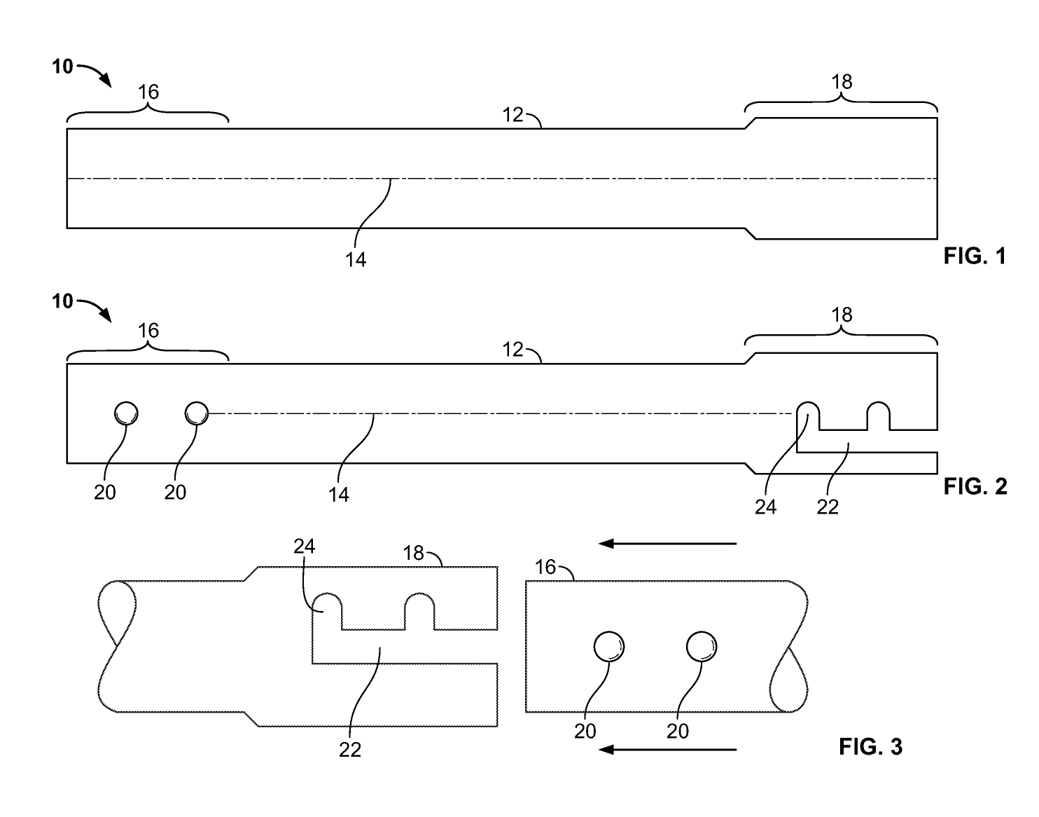

As depicted in the embodiment FIG. 1, a section of conduit 10 may include a standard 10′ long electrical metallic tubing (EMT) or EMT pipe 12. Alignment marks 14 along the major axis of the pipe or tube may help align with a second section of EMT pipe, which may be painted dashed lines that extend along the exterior of the pipe 12. The pipe 12 may have a fitting male end 16 and a female end 18.

As depicted in the embodiment of FIG. 2, the male end 16 of the pipe 12 may have two pins 20 spaced approximately 1″ apart (such as from 0.8″ to 1.2″, for example) on the exterior surface of the pipe. The opposite end of the pipe (female end 18) may be flared out to accept the male end 16, and may have a slot 22 with pin keepers 24 that correspond to the pins 20.

As depicted in the embodiment of FIG. 3, the pin keepers 24 and slot 22 of the flared female end 18 may be adapted to receive and retain the pins 20 of the male end 16 of another section of conduit. The male end 16 of one pipe and the female end 18 of a second pipe fit together to form a continuous conduit system.

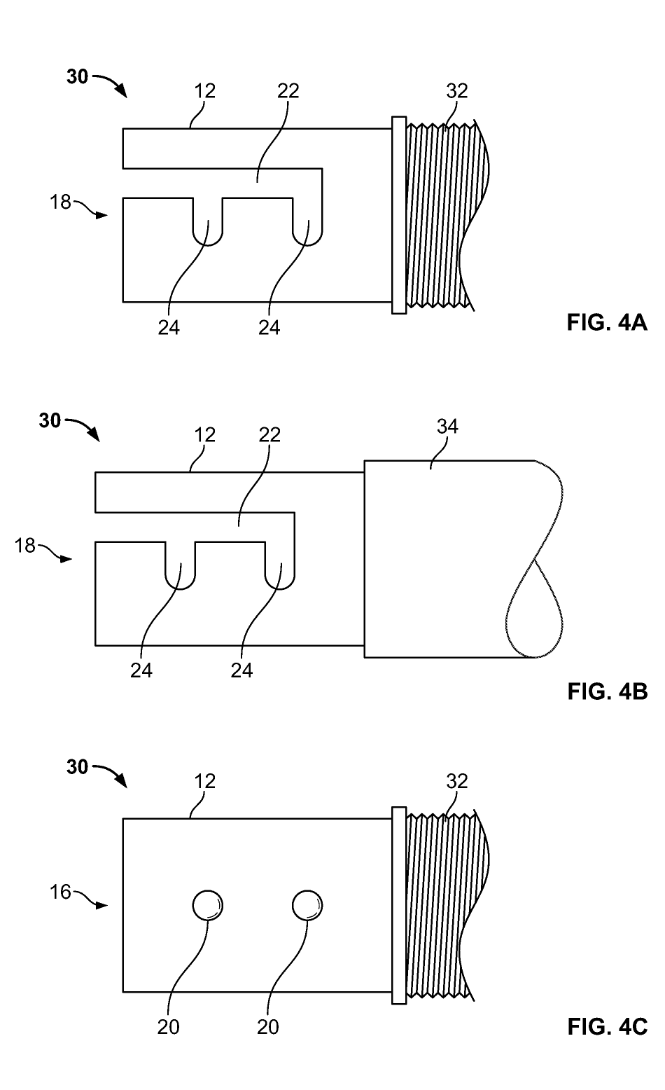

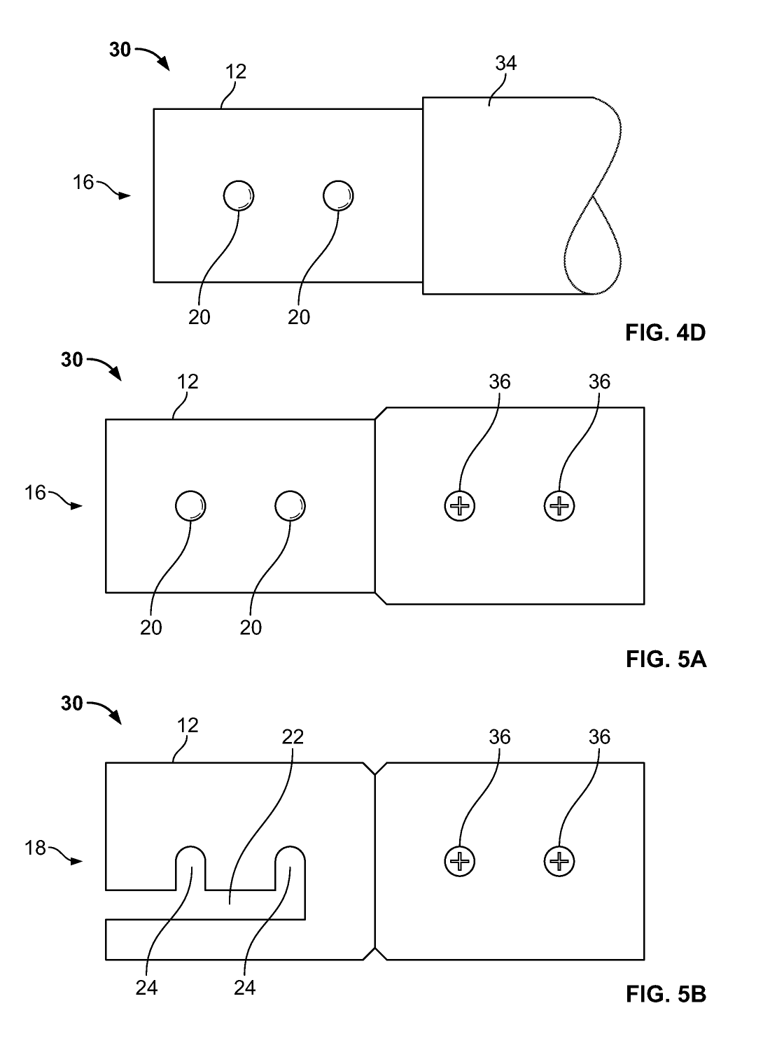

As depicted in the embodiment of FIGS. 4A, 4B, 4C, and 4D, an embodiment of an interconnection end section 30 may include a threaded male adapter 32 or a threaded female adapter 34. These interconnection ends 30 may be used to attach the conduit 10 to external fixtures, such as a fixed box or connector. The additional connections and/or adapters may be near the fitting male end or the fitting female end of the conduit. FIG. 4A depicts one end of a pipe 12 with female end 18, slot 22, and pin keepers 24, and the other end with a threaded male adapter 32. FIG. 4B depicts the pipe with female end, and the other end with a threaded female adapter 34. FIG. 4C depicts the pipe 12 with the male end 16 and pins 20, and the other end with threaded male adapter 32. FIG. 4D depicts the pipe with male end and the other end with threaded female adapter 34.

As depicted in the embodiments of FIGS. 5A and 5B, embodiments of an interconnection end section 30 may include set screws 36 with either a fitting male end 16 or a female end 18. A set screw may be a screw, bolt, or other attachment that passes through the outer surface to tighten against the inner surface. In general, embodiments of the invention may include a plurality of interconnected sections of conduit 30, with the end sections having appropriate external fixtures (such as threaded or screw-set leads for an electrical box) to provide a conduit system.

An exemplary embodiment of the present invention may include a 30 degree elbow, a 45 degree elbow, or a 90 degree elbow. An exemplary embodiment may be called a male-female, pin-slot connection system. Any or all conduit, EMT fittings, adapters, and elbow may be designed to fit together quickly, safely, and efficiently to make a complete installation.

The installation of an exemplary embodiment of the present invention may be performed by an electrician. To install an embodiment, a male adapter may be installed at a termination starting point, for example, an electrical box, load center, or existing conduit. The conduit may be aligned and inserted into the adapter. When the conduit is set in place, the installer may rotate the conduit clockwise until it is tightly seated in place, using channel lock pliers. Standard conduit supports may be used with the system. Marker liens on top and bottom of the conduit may assist in alignment and bending of conduit.

In an exemplary embodiment the present invention may save labor and material costs on electrical conduit installation. Embodiments of factory made joints may be 15 degree, 30 degree, 45 degree, or 90 degree elbows, and box offsets may have corresponding offsets of 15 degree, 30 degree, or 45 degree. Other offsets may be manufactured to specific dimensions as needed. Fittings may be designed for installation at concrete, direct burial, or weatherproof locations.

An embodiment may include a conduit system, comprising a pipe having a male end and a female end, the male end having a pin extruding on an exterior surface of the pipe; and the female end having a flared end and a pin keeper, the female end designed to accept the male end.

I claim:

1. A device comprising:
a pipe having a male shape at a first end and a female shape at a second end, the female shape having a flare adapted to accept the male shape;
a pin on an exterior surface of the pipe, having a pin shape; and
a slot in the pipe, adapted to receive and retain the pin shape, thereby providing a section of conduit.

2. The device of claim 1, wherein the pin is on the male shape of the first end and the slot is on the female shape of the second end.

3. The device of claim 1, wherein the first end includes a plurality of pins and the second end includes the slot with a plurality of pin keepers that correspond to the plurality of pins, thereby providing a pin-slot connection system.

4. The device of claim 1, wherein the section of conduit includes two pins, spaced along the pipe between 0.8″ and 1.2″ apart, and the slot has two pin keepers that correspond to the pins.

5. The device of claim 1, further comprising:
an alignment mark to help align the (first) section of conduit with a second section of conduit, so that the pin of the first section of conduit can engage with the slot of the second section of conduit.

6. The device of claim 5, wherein the alignment mark includes a dashed line along a major axis of the pipe.

7. The device of claim 1, further comprising a second section of conduit that includes:
a second pipe;
a third end on the second pipe, adapted to engage with either the first end or second end of the (first) section of conduit; and
a fourth end on the second pipe, adapted to engage with an external fixture, thereby providing an installable conduit system.

8. The device of claim 7, wherein the fourth end of the second pipe includes a threaded adapter.

9. The device of claim 7, wherein the fourth end of the second pipe includes a set screw.

10. The device of claim 1, wherein the pipe is electrical metallic tubing.

11. The device of claim 1, further comprising:
a joint, having a non-zero degree angle.

12. A conduit system, comprising:
a pipe having a male end and a female end;
the pipe having a flare near the female end of the pipe, adapted to accept the male end of a second pipe to form a continuous conduit system;
a plurality of pins, extruding on an exterior surface near the male end; and
a slot near the female end, having a plurality of pin keepers that correspond to the pins, to retain the pipe to the second pipe.

13. The conduit system of claim 12, further comprising:
a plurality of pins on the male end having a pin shape; and
a slot on the second end having a plurality of pin keepers that correspond to the plurality of pins.

14. The conduit system of claim 12, further comprising:
a dashed line along a major axis of the pipe, to help align with the second pipe.

15. The device of claim 12, further comprising a second pipe having:
an interconnection end adapted to engage with one of either the male end or female end of the (first) pipe; and
an external end adapted to connect with an external fixture.

16. A method for a conduit system, comprising:
providing a first pipe having a male shape at a first end, a pin on an exterior surface near the first end, a female, flared shape at a second end, and a pin keeper near the second end;
attaching a similar second pipe to the first pipe so that the pin of the first pipe and the pin keeper of the second pipe engage to retain the first pipe to the second pipe; and
attaching a third pipe to the first pipe and to an external fixture.

17. The method of claim 16, further comprising:
aligning a first alignment mark on the first pipe with a second alignment mark on the second pipe; and
engaging the pin of the first pipe with the slot of the second pipe so as to retain the first pipe to the second pipe.

18. The method of claim 16, further comprising:
after attaching the second pipe to the first pipe, rotating the first pipe relative to the first pipe to align the alignment marks of the pipes.
